(19) United States
(12) Patent Application Publication
(10) Pub. No.: US 2024/0145967 A1
(43) Pub. Date: May 2, 2024

(54) Conductive Terminal and Electrical Connector Having the Same

(71) Applicants: Tyco Electronics (Shanghai) Co., Ltd., Shanghai (CN); Tyco Electronics (Qingdao) Ltd., Qingdao (CN)

(72) Inventors: Liming (Eric) Wang, Shanghai (CN); Daiqiong (Diana) Zhang, Shanghai (CN); Wende Zhao, Qingdao (CN); Shilong Wu, Qingdao (CN); Xinxin (Daisy) Li, Shanghai (CN); Zhenyu (Richard) Chen, Shanghai (CN); Jialin Zhang, Shanghai (CN); Zhongxi Huang, Shanghai (CN)

(73) Assignees: Tyco Electronics (Shanghai) Co., Ltd., Shanghai (CN); Tyco Electronics (Qingdao) Ltd., Qingdao (CN)

(21) Appl. No.: 18/498,633

(22) Filed: Oct. 31, 2023

(30) Foreign Application Priority Data
Oct. 31, 2022 (CN) 202211345536.8

(51) Int. Cl. H01R 13/03

(52) U.S. Cl. CPC H01R 13/03

(57) ABSTRACT

A conductive terminal includes a conductive base substrate and a plating layer structure plated on the conductive base substrate. The plating layer structure includes a nickel plating layer located outside the conductive base substrate, a silver plating layer located outside the nickel plating layer, and a platinum-based polymetallic plating layer located outside the silver plating layer.

### CROSS-REFERENCE TO RELATED APPLICATIONS

This application claims the benefit of the filing date under 35 U.S.C. § 119(a)-(d) of Chinese Patent Application No. 202211345536.8, filed on Oct. 31, 2022.

### FIELD OF THE INVENTION

The present disclosure relates to the field of plating, and in particular to a conductive terminal and an electrical connector having the same.

### BACKGROUND

An electrical connector is used for transmitting data signals and/or electrical energy and is generally such configured that various electrical contacts mate one another along the friction distance, and the mating ends apply positive pressure to one another to maintain good contact between the mated electrical contacts. During use, the electrical connector will be affected by the thermal expansion and vibration associated with the electrical contacts, so that relative micro-movement occurs at the contact point, resulting in local wear. In addition, some electrical connectors are subject to a lot of repeated plugging and unplugging, which will cause wear due to friction at the mating ends.

As a well-known conductor more suitable for the electrical contact of an electrical connector than gold, silver is coated or deposited purely chemically or electrochemically on electrical contacts, having the advantages of lower cost, better thermal and electric conductivity. However, silver (with hardness of about 100 Hv) is significantly softer and more vulnerable to wear than gold (with hardness of about 180 Hv). Further, silver is not resistant to any acid or alkali corrosion, and is extremely easy to oxidize and vulcanize in the ambient of warm and humid, coastal, and industrial waste gas, whereby the electrical performance thereof degrades or is even lost.

In order to reduce the probability of corrosion, wear, and discoloration of silver plating, a common method in the prior art is to coat an extremely thin organic film or an inorganic film on the outer surface of the silver plating to lubricate and seal, so as to reduce the probability of corrosion, wear and discoloration of the silver plating. A common application in daily life is to coat silver jewelry with a thin layer of rhodium or gold and/or further with an organic transparent film or lubricant.

In recent years, adding a thin layer of gold on the surface of the silver plating of the terminal is also proposed in the field of electrical connectors to replace the method of plating a thick layer of gold on the terminal, thereby reducing the cost. Moreover, the surface of the gold layer is protected by an organic film or lubricant, which will not significantly increase the contact resistance of the surface layer, but can prevent the silver plating from discoloring and improve its wear resistance and corrosion resistance. The prior art also notes that rhodium can be plated on the surface of the silver plating of the terminal. However, the above solutions still have the problems of high cost and limited wear and corrosion resistance of the plating.

### SUMMARY

A conductive terminal includes a conductive base substrate and a plating layer structure plated on the conductive base substrate. The plating layer structure includes a nickel plating layer located outside the conductive base substrate, a silver plating layer located outside the nickel plating layer, and a platinum-based polymetallic plating layer located outside the silver plating layer.

### BRIEF DESCRIPTION OF THE DRAWINGS

Features of the present invention will become more apparent by describing in detail exemplary embodiments thereof with reference to the accompanying drawings, in which:

FIG. 1 is a schematic view of a conductive terminal according to an embodiment of the present disclosure;

FIG. 2 is a schematic view of another conductive terminal according to an embodiment of the present disclosure;

FIG. 3 is a schematic view of another conductive terminal according to an embodiment of the present disclosure;

FIG. 4 is a schematic view of another conductive terminal according to an embodiment of the present disclosure;

FIG. 5 is a schematic view of another conductive terminal according to an embodiment of the present disclosure;

FIG. 6 is a schematic view of another conductive terminal according to an embodiment of the present disclosure;

FIG. 7 is a schematic view of another conductive terminal according to an embodiment of the present disclosure;

FIG. 8 is a schematic view of another conductive terminal according to an embodiment of the present disclosure;

FIG. 9 is a schematic view of another conductive terminal according to an embodiment of the present disclosure;

FIG. 10 is a schematic view of another conductive terminal according to an embodiment of the present disclosure;

FIG. 11 is a schematic view of another conductive terminal according to an embodiment of the present disclosure; and

FIG. 12 is a schematic view of another conductive terminal according to an embodiment of the present disclosure.

### DETAILED DESCRIPTION OF EXEMPLARY EMBODIMENTS

The implementation and usage of the embodiments are discussed in detail below. However, it is should be understood that the specific embodiments discussed herein are merely intended to illustrate specific ways of implementing and applying the present disclosure, and are not intended to limit the scope of the present disclosure. When describing the components, the expressions used herein, such as “upper”, “lower”, “left”, “right”, “top”, and “bottom”, are not absolute, but relative. When the components are arranged as shown in the drawings, these expressions are appropriate, but when the positions of these components in the drawings are altered, these expressions should be altered accordingly.

A plating layer structure proposed in an embodiment of the present disclosure is particularly applicable to a conductive terminal of the electrical connector. Compared with the prior art, it can effectively improve the wear and corrosion resistance of the conductive terminal of the electrical connector, improve the surface luster of the conductive terminal and reduce discoloration, and reduce the production cost of the electrical connector.

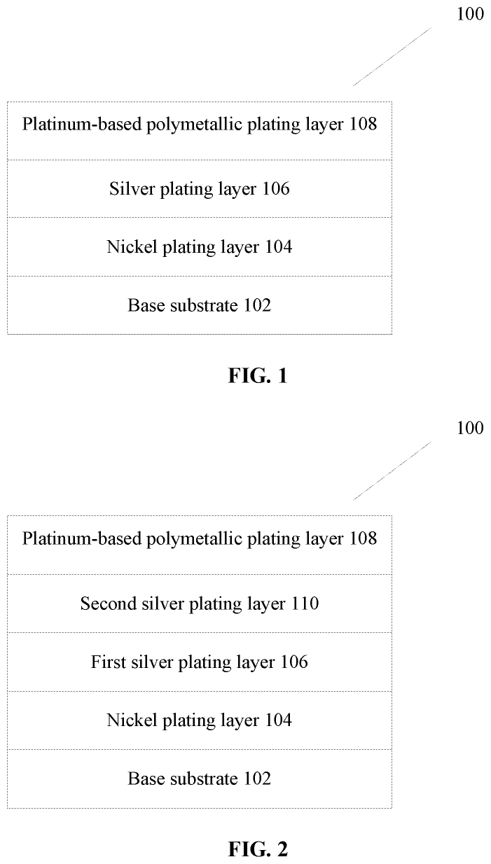

FIG. 1 shows a schematic structural view of a conductive terminal 100 according to an embodiment of the present disclosure. The conductive terminal 100 includes: a conductive base substrate 102 and a plating layer structure plated on the conductive base substrate 102. The plating layer structure includes: a nickel plating layer 104, a silver plating layer 106, and a platinum-based polymetallic plating layer 108. The nickel plating layer 104 is located outside the conductive base substrate 102. The silver plating layer 106 is located outside the nickel plating layer 104. The platinum-based polymetallic plating layer 108 is located outside the silver plating layer 106.

In this embodiment, the platinum-based polymetallic plating layer 108 is additionally plated on the silver plating layer 106 of the conductive terminal 100. The platinum-based polymetallic plating layer 108 substituting the existing gold plating layer has the following advantages. Firstly, platinum (with hardness of min 450 Hv) has higher hardness than gold (with hardness of 180 Hv), which is good for improving the wear resistance of the terminal 100. The cost of platinum is about 50% of that of gold, significantly reducing the production cost of electrical connectors. Secondly, platinum is similar to silver in color and luster, which is good for improving the surface luster of the terminal and reducing discoloration. In addition, the density of platinum (21.45) is higher than that of gold (19.3), and it is easier to obtain a dense nanocrystalline structure of platinum through plating. Under the premise of a thin plating layer with nano thickness, the compactness and covering capacity of platinum will be superior to that of gold, which can improve the corrosion resistance of the silver plating layer 106.

In some examples, the base substrate 102 is a copper alloy base substrate which has the hardness and resilience required for the terminal 100. In some examples, the nickel plating layer 104 may be a nickel plating layer of a nanocrystalline structure or a nickel plating layer of a conventional structure. In some examples, the silver plating layer 106 may be silver alloy (hard silver) or pure silver. In some examples, the platinum-based polymetallic plating layer 108 may be a nanocrystalline platinum-based alloy plating layer (that is, platinum alloy with a nanocrystalline structure, such as platinum-silver, platinum-palladium, platinum-gold, palladium-silver, palladium-gold, and rhodium-ruthenium), or a platinum-based inter-metallic compounds (IMC) plating layer (that is, a plating layer formed by diffusion of elements from two adjacent different metal layers, typically consisting of two or more kinds of metal atoms, such as platinum-silver compounds plating layer).

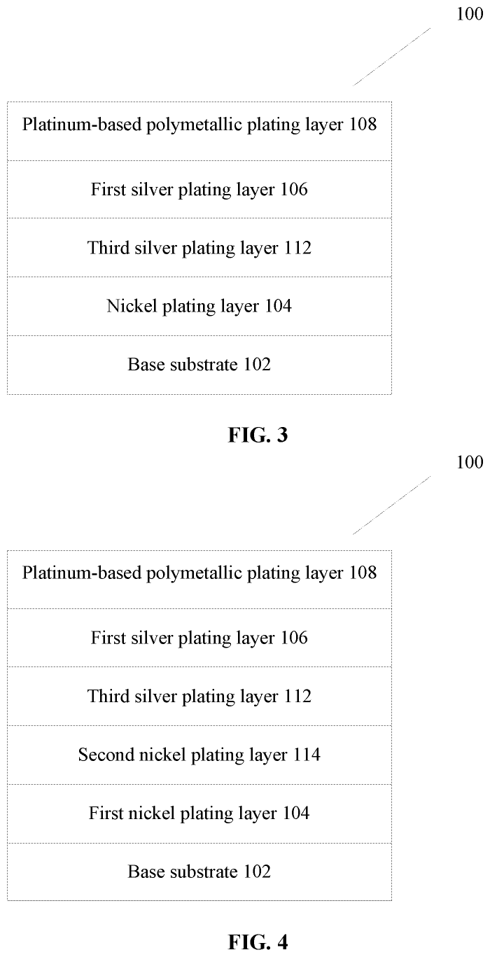

In an exemplary embodiment, as shown in FIG. 2, the silver plating layer 106 is a first silver plating layer, and the plating layer structure further includes: a second silver plating layer with a nanocrystalline structure 110 (that is, nanocrystalline silver plating layer), located outside the first silver plating layer 106. The platinum-based polymetallic plating layer 108 is located outside the second silver plating layer 110. In the present embodiment, a thin layer of nanocrystalline silver is additionally provided between the silver plating layer 106 and the platinum-based polymetallic plating layer 108 to enhance the compactness of the plating layers and the bonding force between the plating layers, which is more resistant to the thermal diffusion and thermal expansion of metal caused by raised temperature resulting from the long-time working of the connector, that is, improves the heat resistance of the conductive terminal 100.

In an exemplary embodiment, as shown in FIG. 3, the silver plating layer 106 is a first silver plating layer, and the plating layer structure further includes: a third silver plating layer with a nanocrystalline structure 112, located outside the nickel plating layer 104. The first silver plating layer 106 is located outside the third silver plating layer 112. In the present embodiment, a thin layer of nanocrystalline silver plating is additionally provided between the nickel plating layer 104 and the first silver plating layer 106 to enhance the compactness and the bonding force between the plating layers, which is more resistant to the thermal diffusion and thermal expansion of metal caused by raised temperature resulting from the long-time working of the connector, that is, improves the heat resistance of the conductive terminal 100.

In an exemplary embodiment, as shown in FIG. 4, the nickel plating layer 104 is a first nickel plating layer, and the plating layer structure further includes: a second nickel plating layer with a nanocrystalline structure 114, located outside the first nickel plating layer 104. The third silver plating layer 112 is located outside the second nickel plating layer 114. In the present embodiment, a thin layer of nanocrystalline silver plating and a thin layer of nanocrystalline nickel plating are additionally provided between the first nickel plating layer 104 and the first silver plating layer 106 to enhance the compactness of the plating layers and the bonding force between the plating layers, which is more resistant to the thermal diffusion and thermal expansion of metal caused by raised temperature resulting from the long-time working of the connector, that is, improves the heat resistance of the conductive terminal 100.

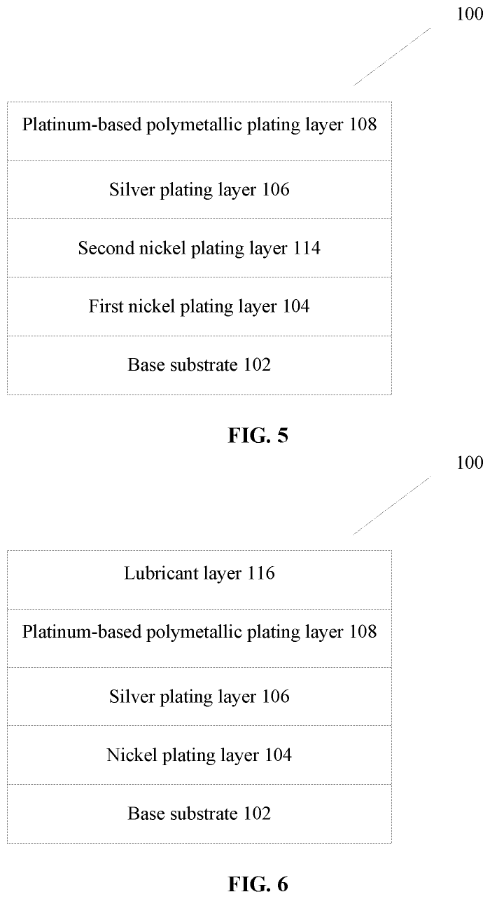

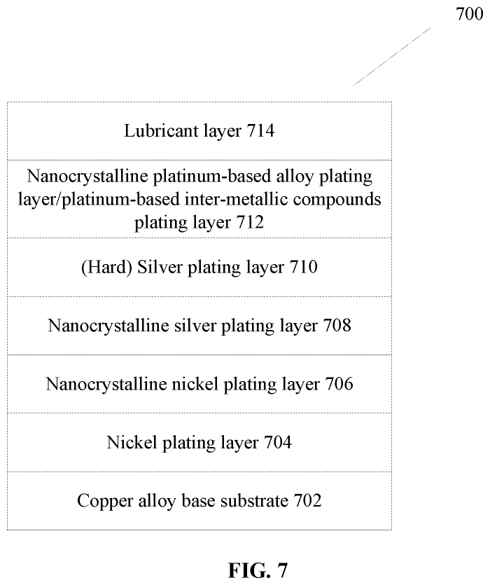

In an exemplary embodiment, as shown in FIG. 5, the nickel plating layer 104 is a first nickel plating layer, and the plating layer structure further includes: a second nickel plating layer with a nanocrystalline structure 114, located outside the first nickel plating layer 104. The silver plating layer 106 is located outside the second nickel plating layer 114. In the present embodiment, a thin layer of nanocrystalline nickel plating is additionally provided between the first nickel plating layer 104 and the first silver plating layer 106 to enhance the compactness of the plating layers and the bonding force between the plating layers, which is more resistant to the thermal diffusion and thermal expansion of metal caused by raised temperature resulting from the long-time working of the connector, that is, improves the heat resistance of the conductive terminal 100.

In some examples, the conductive terminal 100, as shown in FIG. 6, further includes a lubricant layer 116 located at the outmost of the plating layer structure to lubricate and seal, so as to reduce the chance of corrosion, wear, and discoloration of the silver plating layer 106. The lubricant layer 116 may be lubricating oil containing organic materials such as mercaptan, perfluoro, olefin, or polyether.

FIG. 7 shows a schematic view of another conductive terminal 700 according to an embodiment of the present disclosure. The conductive terminal 700 includes: a copper alloy base substrate 702 and a plating layer structure plated on the copper alloy base substrate 702. The plating layer structure includes: a nickel plating layer 704, a nanocrystalline nickel plating layer 706, a nanocrystalline silver plating layer 708, a silver plating layer 710 (hard silver or pure silver), and a nanocrystalline platinum-based alloy plating layer or platinum-based inter-metallic compounds plating layer 712. The conductive terminal 700 further includes a lubricant layer 714.

FIG. 8 shows a schematic view of another conductive terminal 800 according to an embodiment of the present disclosure. The conductive terminal 800 includes: a copper alloy base substrate 802 and a plating layer structure plated on the copper alloy base substrate 802. The plating layer structure includes: a nickel plating layer 804, a nanocrystalline nickel plating layer 806, a silver plating layer 808 (hard silver or pure silver), and a nanocrystalline platinum-based alloy plating layer or platinum-based inter-metallic compounds plating layer 810. The conductive terminal 800 further includes a lubricant layer 812.

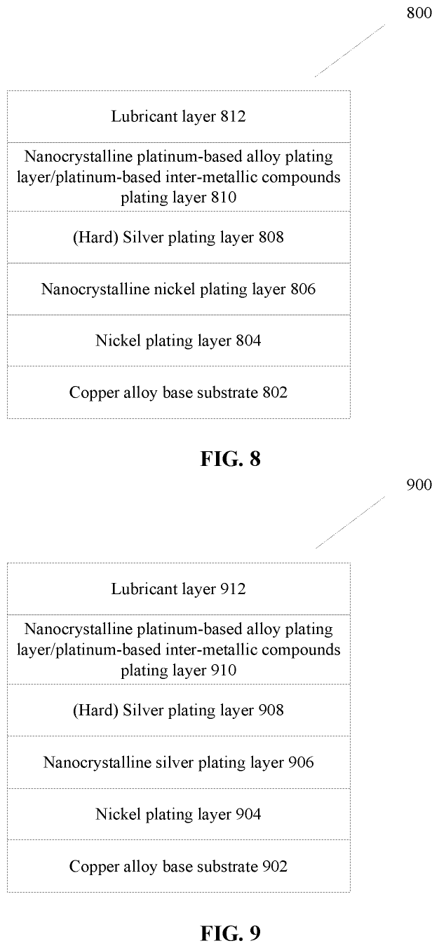

FIG. 9 shows a schematic view of another conductive terminal 900 according to an embodiment of the present disclosure. The conductive terminal 900 includes: a copper alloy base substrate 902 and a plating layer structure plated on the copper alloy base substrate 902. The plating layer structure includes: a nickel plating layer 904, a nanocrystalline silver plating layer 906, a silver plating layer 908 (hard silver or pure silver), and a nanocrystalline platinum-based alloy plating layer or platinum-based inter-metallic compounds plating layer 910. The conductive terminal 900 further includes a lubricant layer 912.

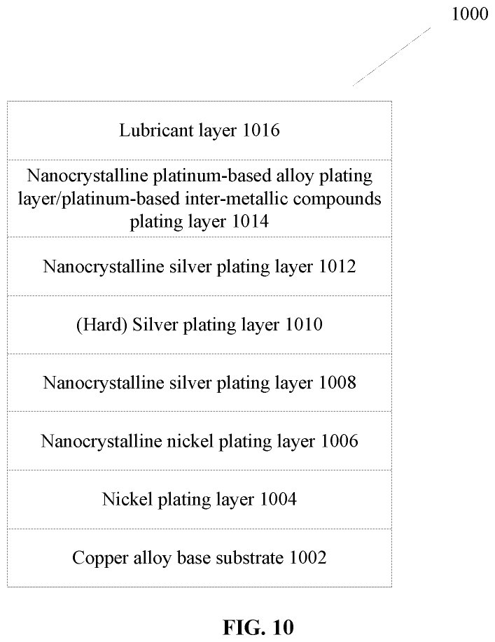

FIG. 10 shows a schematic view of another conductive terminal 1000 according to an embodiment of the present disclosure. The conductive terminal 1000 includes: a copper alloy base substrate 1002 and a plating layer structure plated on the copper alloy base substrate 1002. The plating layer structure includes: a nickel plating layer 1004, a nanocrystalline nickel plating layer 1006, a nanocrystalline silver plating layer 1008, a silver plating layer 1010 (hard silver or pure silver), a nanocrystalline silver plating layer 1012, and a nanocrystalline platinum-based alloy plating layer or platinum-based inter-metallic compounds plating layer 1014. The conductive terminal 1000 further includes a lubricant layer 1016.

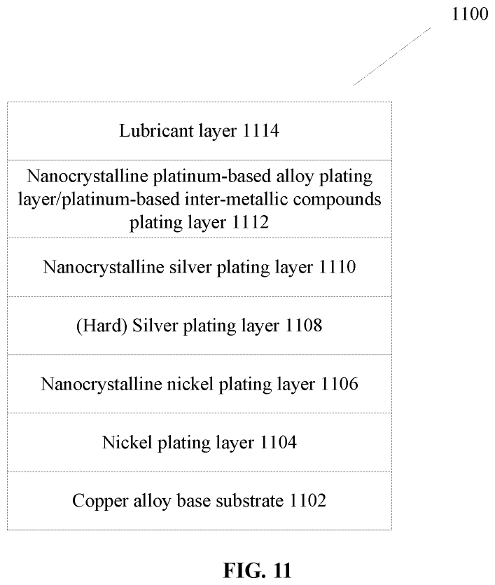

FIG. 11 shows a schematic view of another conductive terminal 1100 according to an embodiment of the present disclosure. The conductive terminal 1100 includes: a copper alloy base substrate 1102 and a plating layer structure plated on the copper alloy base substrate 1102. The plating layer structure includes: a nickel plating layer 1104, a nanocrystalline nickel plating layer 1106, a silver plating layer 1108 (hard silver or pure silver), a nanocrystalline silver plating layer 1110, and a nanocrystalline platinum-based alloy plating layer or platinum-based inter-metallic compounds plating layer 1112. The conductive terminal 1100 further includes a lubricant layer 1114.

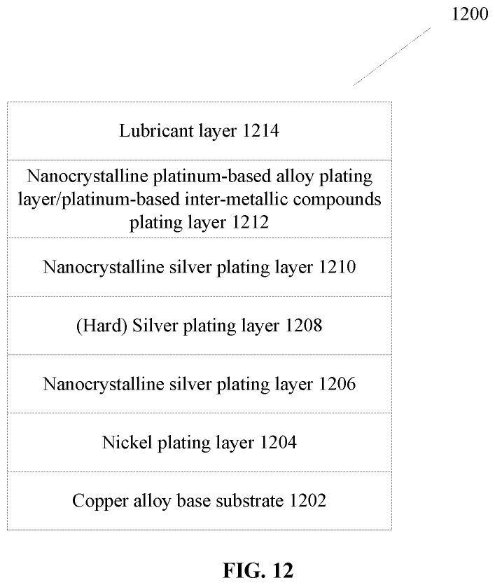

FIG. 12 shows a schematic view of another conductive terminal 1200 according to an embodiment of the present disclosure. The conductive terminal 1200 includes: a copper alloy base substrate 1202 and a plating layer structure plated on the copper alloy base substrate 1202. The plating layer structure includes: a nickel plating layer 1204, a nanocrystalline silver plating layer 1206, a silver plating layer 1208 (hard silver or pure silver), a nanocrystalline silver plating layer 1210, and a nanocrystalline platinum-based alloy plating layer or platinum-based inter-metallic compounds plating layer 1212. The conductive terminal 1200 further includes a lubricant layer 1214.

An electrical connector is provided according to another embodiment of the present disclosure, which includes the conductive terminal described above. The structure of the electrical connector of the present embodiment is the same as or similar to that of the previous embodiment, and will not be repeated herein.

Although the present disclosure has been described with reference to specific examples, these examples are merely illustrative and not intended to limit the present disclosure. It is obvious to those skilled in the art that changes, additions, or deletions to the disclosed embodiments can be made without departing from the spirit and scope of protection of the present disclosure.

What is claimed is:

1. A conductive terminal, comprising:
a conductive base substrate; and
a plating layer structure plated on the conductive base substrate, the plating layer structure includes a nickel plating layer located outside the conductive base substrate, a silver plating layer located outside the nickel plating layer, and a platinum-based polymetallic plating layer located outside the silver plating layer.

2. The conductive terminal according to claim 1, wherein the platinum-based polymetallic plating layer is a nanocrystalline platinum-based alloy plating layer or platinum-based inter-metallic compounds plating layer.

3. The conductive terminal according to claim 1, wherein the silver plating layer is a first silver plating layer, and the plating layer structure includes a second silver plating layer with a nanocrystalline structure located outside the first silver plating layer.

4. The conductive terminal according to claim 3, wherein the platinum-based polymetallic plating layer is located outside the second silver plating layer.

5. The conductive terminal according to claim 1, wherein the silver plating layer is a first silver plating layer, and the plating layer structure includes a third silver plating layer with a nanocrystalline structure located outside the nickel plating layer.

6. The conductive terminal according to claim 5, wherein the first silver plating layer is located outside the third silver plating layer.

7. The conductive terminal according to claim 6, wherein the nickel plating layer is a first nickel plating layer, and the plating layer structure includes a second nickel plating layer with a nanocrystalline structure located outside the first nickel plating layer.

8. The conductive terminal according to claim 7, wherein the third silver plating layer is located outside the second nickel plating layer.

9. The conductive terminal according to claim 1, wherein the nickel plating layer is a first nickel plating layer, and the plating layer structure includes a second nickel plating layer with a nanocrystalline structure located outside the first nickel plating layer.

10. The conductive terminal according to claim 9, wherein the silver plating layer is located outside the second nickel plating layer.

11. The conductive terminal according to claim 1, wherein the nickel plating layer is a nanocrystalline nickel plating layer.

12. The conductive terminal according to claim 1, further a lubricant layer at an outmost side of the plating layer structure.

13. The conductive terminal according to claim 1, wherein the platinum-based polymetallic plating layer is a platinum-based inter-metallic compounds plating layer.

14. The conductive terminal according to claim 13, wherein the platinum-based inter-metallic compounds plating layer is a platinum-silver compounds plating layer.

15. An electrical connector, comprising:
a conductive terminal including a conductive base substrate and a plating layer structure plated on the conductive base substrate, the plating layer structure includes a nickel plating layer located outside the conductive base substrate, a silver plating layer located outside the nickel plating layer, and a platinum-based polymetallic plating layer located outside the silver plating layer.
